(19) United States
(12) Patent Application Publication
(10) Pub. No.: US 2009/0021702 A1
(43) Pub. Date: Jan. 22, 2009

(54) Multi-projection kiosk for digital signage

(76) Inventors: Todd A. Cleland, Corvallis, OR (US); Thomas M. Carrico, Corvallis, OR (US); William R. Wagner, Escondido, CA (US); Steven W. Greer, Corvallis, OR (US); Ron R. Bendsneyder, Albany, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/880,196

(22) Filed: Jul. 20, 2007

(51) Int. Cl. G03B 21/16

(52) U.S. Cl. 353/58; 353/121

(57) ABSTRACT

A projection kiosk for a multi-projector digital signage system includes an enclosure and a frame disposed therein. The frame includes attachment points which can hold in position a plurality of projectors. The projectors may be aligned with sub-pixel-resolution accuracy to enable projection of pixel-aligned images onto a screen. The enclosure includes a heat ducting subsystem configured to direct air into the enclosure, duct air through the projectors, and discharge air away from a projection path between the plurality of projectors and the screen.

### BACKGROUND

Images can be displayed by projecting light onto large screens using various projection technologies. Such large screen displays can find applications in advertising, trade-show displays, and the like. Unfortunately, while larger displays can garner greater attention, providing adequate brightness on increasingly large screens requires increasing the level of light output from the projector. Increasing the light levels also result in increased heat and other challenges that cause costs to increase rapidly as higher light levels are provided. To provide a sufficiently bright image can be particularly challenging in a well-lighted environment.

Additional challenges in large screen displays can include installation of the projection equipment. Differing venues may present different available mounting locations. For example, different ceiling heights of venues can lead to customization of the projector mounting in a ceiling-mount application. Floor mounting of projectors can result in unacceptable shadowing from personnel walking in front of the projector. Rear-projection systems can require large amounts of space.

### BRIEF DESCRIPTION OF THE DRAWINGS

Features and advantages of the invention will be apparent from the detailed description which follows, taken in conjunction with the accompanying drawings which together illustrate, by way of example, features of the invention; and, wherein:

FIG. 1 is a perspective illustration of a projection kiosk in accordance with an embodiment of the present invention;

FIG. 2 is a perspective illustration showing the projection kiosk of FIG. 1 having a plurality of projectors mounted therein and projecting an image onto a screen in accordance with an embodiment of the present invention;

FIG. 3 is a perspective illustration of the projection kiosk of FIG. 1 showing heat flow paths through the enclosure in accordance with an embodiment of the present invention; and

FIG. 4 is a perspective illustration of a projection kiosk having wings and additional features in accordance with an embodiment of the present invention.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “a component surface” includes reference to one or more of such surfaces.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill in the art.

Reference will now be made to the exemplary embodiments illustrated, and specific language will be used herein to describe the same. It will nevertheless be understood that no limitation of the scope of the invention is thereby intended.

In view of the problems and difficulties presented by the prior art, a projection kiosk for projector-based digital signage has been invented. The projection kiosk can provide a mounting location for multiple projectors, workstations, cameras, and the like. The kiosk can also provide a secure enclosure for the equipment appropriate for use in a public venue. Interior mounting points can be provided for multiple projectors.

Multiple projectors can provide increased brightness for the display. For example, the display brightness may be increased by projecting the same image onto the screen using multiple projectors. Four projectors can provide about a four-fold increase in brightness compared to that of a single projector; six projectors can provide about a six-fold increase in brightness, etc. As another example, a large screen can be partitioned into multiple sub-images, each sub-image being projected by a single projector or split among several projectors. In either case, the images projected by the projectors are preferably aligned to sub-pixel-resolution accuracy to help maintain resolution of the overall projected image.

Using multiple projectors, rather than a single large monolithic projector provides a number of advantages. When multiple projectors provide overlapping sub-images, the resulting redundancy provides enhanced reliability for the projection system. Another benefit is that the cost of two projectors is generally less than the cost of one projector having twice the brightness. Of course, some complexity is incurred in aligning the multiple projectors. For example, to provide a particular pixel size resolution, overlapping or abutting images are aligned to sub-pixel, or a fraction of a pixel accuracy.

One particular difficulty when using multiple sub-pixel-resolution aligned projectors is maintaining the proper alignment. For example, heat gradients within the projection path between the projectors and the screen can cause optical refraction (bending) of the projected beams. Since the beams from the multiple projectors do not follow exactly the same path, sub-images from different projectors may be distorted by the heat gradients differently, causing misalignment of the sub-images and reducing resolution or clarity of the overall image on the screen. This effect may be more pronounced when multiple projectors are used than a single projector. With a single projector, heat-gradients may result in subtle distortion of the image, but without loss of resolution. With multiple projectors, however, the heat gradients distort the multiple images in different ways, resulting in loss of resolution in addition to image distortion. Accordingly, simply stacking multiple projectors on top of each other without controlling heat flow has been observed to result in wavy lines, ripples, or ghosting in the projected image caused by heated air from the projectors flowing into the projection path.

Accordingly, a projection kiosk which includes heat ducting to guide heat generated by the projectors away from the projection path between the projectors and the screen has been invented. By guiding heat away from the projection path, alignment-destroying heat gradients within the projection path can be reduced.

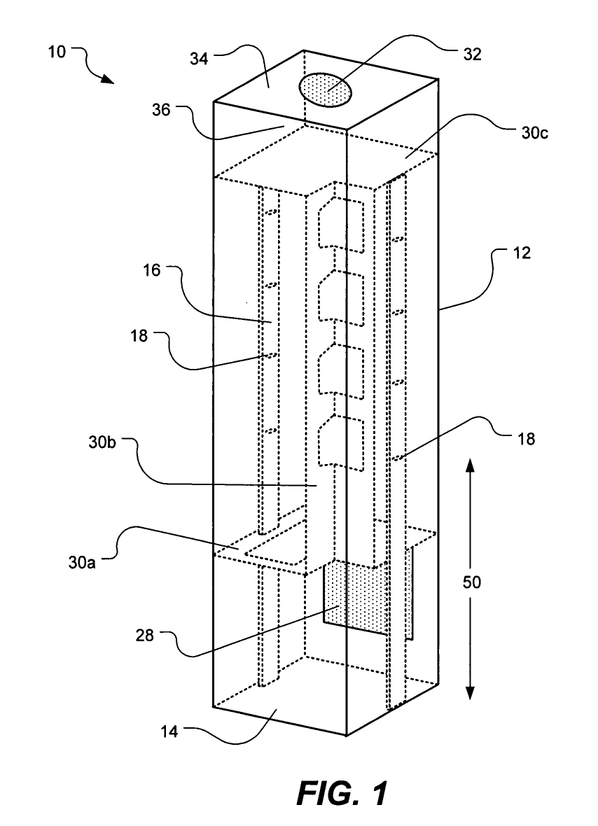

FIG. 1 provides an illustration of a projection kiosk, shown generally at 10, in accordance with an embodiment of the present invention. The projection kiosk includes an enclosure 12 having a supporting base 14. A frame 16 is disposed within the enclosure, and provides attachment points 18 to hold in position a plurality of projectors. The projectors can be configured to be aligned with sub-pixel-resolution accuracy to enable projection of pixel-aligned images onto a screen.

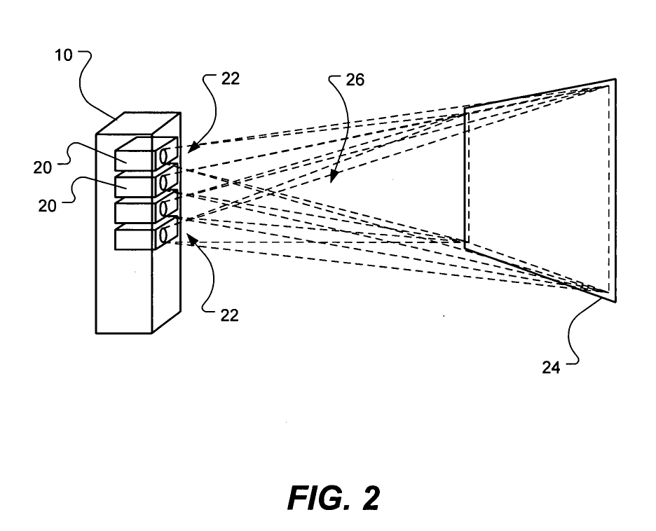

For example, FIG. 2 illustrates the projection kiosk 10 having a plurality of projectors 20 installed therein. The plurality of projectors project image components 22 onto a screen 24 to form an image thereon. The image components can be aligned with sub-pixel-resolution accuracy. For example, alignment can be provided by using physical alignment of the projectors within the projection kiosk, software-based alignment of the projected image components, or both. More particularly, alignment of the images may be performed by software-controlled adjustment of the projected images, using a camera to image the screen and provide feedback to the software.

The projection kiosk 10 can include a heat ducting subsystem to guide heat generated by the plurality of projectors 20 away from the light projection path 26 between the plurality of projectors and the screen 24. For example, referring back to FIG. 1, the heat ducting subsystem may be disposed within the enclosure 12 and include an air intake 28, baffles 30a, 30b, 30c, and an air discharge 32. Air external to the enclosure can be drawn into the enclosure, for example using a fan mounted within the enclosure. The baffles may direct air through the plurality of projectors and out the air discharge. The air discharge can be positioned to direct air away from the projection path. For example, the air discharge may be located in the top 34 of the projection disclosure (as shown) or in the back side 36 of the projection disclosure, away from the side facing the screen. By avoiding the discharge of heated air into the projection path, this helps to minimize resolution-destroying heat gradients. An additional advantage of discharging air out the top of the enclosure is that heated air is removed from the vicinity of personnel that may be interacting with the kiosk or viewing the projected images.

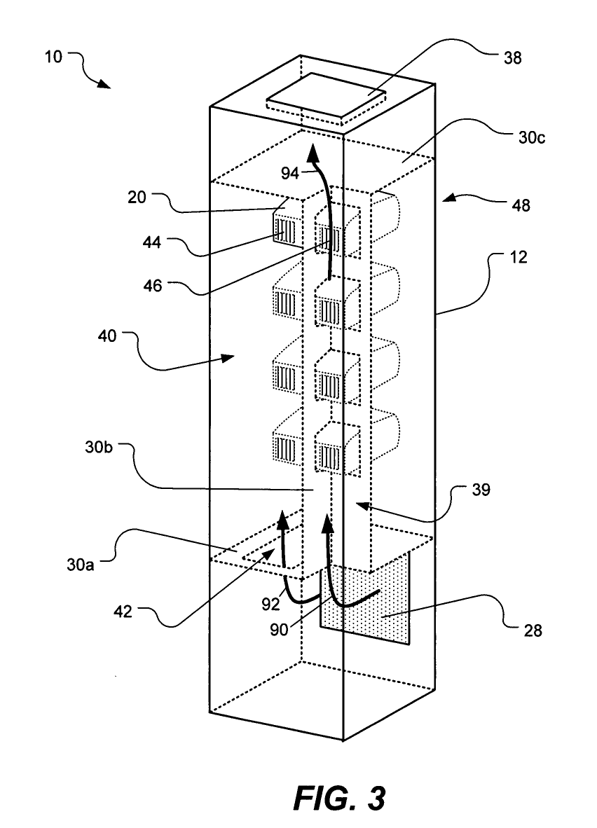

For example, FIG. 3 illustrates air flow paths within the projection kiosk of FIG. 1 with projectors 20 installed therein. Air is drawn through the enclosure by a fan 38 mounted in the air discharge 32. Air flow enters through an air inlet 28, and may flow upward either along path 90 through a duct 39 formed by baffle 30b or along path 92 through a hole 42 in baffle 30a into area 40. Projector inlets 44 accept air from area 40 and discharge heated air via projector outlets 46 into the duct. The fan creates negative pressure within the duct, helping to ensure that heated air from the projectors is drawn upward along path 94 and is not circulated back into area 40 or out of the enclosure near openings for the projector lenses in the front side 48 of the enclosure.

Other arrangements of the heat ducting subsystem may be used. For example, multiple fans can be included, including for example fans located at the air intake, air discharge, and points within the enclosure. The baffle arrangement can be varied to form different shapes of ducts, for example, to accommodate projectors having different air inlet and air outlet arrangements. Air flow may be directed to the plurality of projectors in a serial arrangement (providing a less complex baffle structure), or in a parallel arrangement (as shown here), providing more efficient and even cooling of the projectors.

Returning to FIG. 1, the attachment points 18 for the projectors may be disposed within the enclosure at a height 50 above the supporting base sufficient to minimize shadowing of the projected image by personnel located between the enclosure and the screen. For example, the attachment points may be at a height of at least 4 feet, or more particularly at a height of at least 6 feet. Attaching the projectors high within the projection kiosk can also help to reduce shape distortion of the image (e.g., keystone) for very large screen displays by placing the projectors closer to the centerline of the screen.

As described above, the projection kiosk may be used for projection of images using multiple projectors, for example, to increase resolution and/or brightness of the projected images. The heat ducting subsystem manages the flow of heated air to help avoid producing resolution-destroying heat gradients within the projection path. The projection kiosk may thus be useful in a variety of applications, including for example, a digital signage system such as a point of sale display, advertising display, and the like, and other applications.

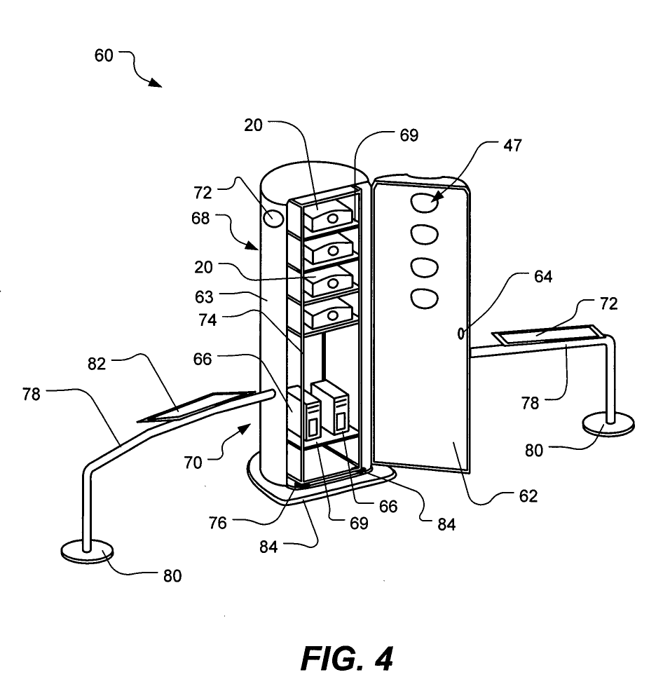

The projection kiosk may also be used as an unattended digital signage display. Additional features that may be included to enhance the operation or aesthetics of the projection kiosk include a secure enclosure, equipment attachment points, speakers, shock isolation of the frame, shelves (or wings), and/or user interfaces as will be now be described. For explanation purposes, FIG. 4 shows a projection kiosk 60 having all of these additional features, although it will be appreciated that these additional features need not be included, or may be included in any combination within a projection kiosk in accordance with embodiments of the present invention.

A secure enclosure can be provided, for example, by including lockable access doors 62 within the enclosure 63. Various types of locks 64 are known in the art which can be used. A secure enclosure can help to protect the projectors, workstations, and other equipment installed within the projection kiosk from theft, vandalism, and accidental damage.

An internal frame 74 can provide attachment points, such as shelves 69, for mounting of projectors 20 and other equipment, such as workstations used to process image data and to provide image signals to the projectors 66 or a camera (not shown). For example, the workstations may be coupled to the projectors to generate images projected by the projectors. A camera may be positioned to view the image on the screen to help in aligning the projectors as described above. Mounting points to mount speakers 72 in or on the enclosure may also be included.

It can be helpful for the projectors to be positioned in the upper portion 68 of the enclosure 63 (to minimize shadowing, as described above). Installing the workstations 66 or other equipment in the lower portion 70 of the enclosure can help to lower the center of gravity of the enclosure. If desired, a counterweight can be included in the lower portion or the supporting base 84 may be fixed to the floor during installation to provide additional stability to the projection kiosk 60.

The internal frame 74 may be shock isolated from the enclosure 63. For example, the internal frame may be attached to the enclosure via one or more shock isolators 76. Various shock isolators are known in the art which can be used. Shock isolation can help to avoid the projected image being disturbed by vibrations transmitted to the enclosure, for example, transmitted through the floor or caused by personnel or equipment bumping into the enclosure. Shock isolation can be particularly advantageous in helping to maintain sub-pixel-resolution alignment of the projectors, since shocks or vibrations may cause the physical alignment of the projectors to change, in turn requiring recalibration of the alignment.

As another example, the internal frame 74 can be separate from the enclosure 63, with the internal frame and enclosure mounted to the floor when installed, but not attached to each other. This can help to provide improved shock isolation for the projectors 20.

Laterally extending shelves or wings 78 can be attached to the enclosure 63 and supported by a foot 80. The shelves or wings can be used, for example, to support displays or merchandise samples. As another example, the shelves or wings can be used to support a user interface 82, such as a touch screen allowing a user to interact with the projection kiosk. The shelves or wings can also provide additional stability to the projection kiosk. If desired, the shelves or wings can also be used to route power and/or data connections into and out of the enclosure.

As a particular example, the projection kiosk may be used as a point of sale display device at a movie theatre. The projection kiosk may project movie trailers onto the screen in the lobby area, and the user interface provide an interaction point for the user to select particular movie trailers for display on the screen, read movie reviews, or to purchase tickets to a selected movie.

The projection kiosk 60 may be arranged in various shapes. For example, as shown here, the kiosk is in the form of a columnar tower. The tower may have various cross sectional shapes, including for example curved face surfaces (e.g. elliptical or round shapes), straight-sided surfaces (e.g. square or rectangular) or combinations thereof. The kiosk need not be a columnar shape, but can take on other geometries, including decorative or entertaining forms, if desired. The kiosk can be covered with materials or objects selected to further achieve desired aesthetic effects. The exterior surface of the enclosure can be used to support additional equipment, such as additional displays (e.g. liquid crystal display panels), lighting, or graphical elements.

A projection kiosk in accordance with the present invention can be assembled in various ways. For example, making a projection kiosk can include forming an enclosure and installing a frame within the enclosure. The enclosure may be constructed of sheet metal, rigid plastic, or other similar materials. The frame can include internal attachment points for installing projectors, for example, as described above. Making the projection kiosk can also include installing a heat ducting subsystem within the enclosure configured, for example, as described above. Installation of additional elements, such as shock isolators, lockable access panels, shelves, etc. can also be included.

The projection kiosk may be provided to customers as a unit without projectors, into which the customer mounts projectors. Alternately, projectors, workstations, cameras, and/or other equipment may be mounted within the frame, and the projection kiosk provided as a completed unit.

Summarizing and reiterating to some extent, a projection kiosk in accordance with embodiments of the present invention can provide a neatly integrated component for a projection-based digital display system. A tower-shaped enclosure includes a mounting frame that allows projectors and associated equipment to be securely mounted and enclosed. The projection kiosk is thus usable in a variety of different environments. The kiosk can elevate the projectors to a height sufficient to minimize shadowing of the screen, without requiring customization to different ceiling heights. Heat flow within the projection kiosk is controlled to help avoid introducing heat into the projection path that could reduce resolution of sub-pixel-aligned multi-projector formed images. Heat can be vented out the top of the tower, removing the heat from the immediate vicinity of the projection kiosk where personnel are likely to congregate in certain applications.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A projection kiosk for a multi-projector digital signage system, comprising:
an enclosure having a supporting base;
a frame disposed within the enclosure having attachment points configured to hold in position a plurality of projectors configurable to be aligned with sub-pixel-resolution accuracy to enable projection of pixel-aligned images onto a screen; and
a heat ducting subsystem disposed within the enclosure and having (i) an intake to accept air external to the enclosure, (ii) baffles to direct air through the plurality of projectors, and (iii) an air discharge positioned to direct air away from a projection path between the plurality of projectors and the screen.

2. The projection kiosk of claim 1, wherein the frame is coupled to the enclosure via at least one shock isolator.

3. The projection kiosk of claim 1, wherein the frame comprises attachment points configured to hold a workstation.

4. The projection kiosk of claim 1, wherein the enclosure comprises at least one access door.

5. The projection kiosk of claim 4, wherein the at least one access door comprises a lock.

6. The projection kiosk of claim 1, further comprising at least one speaker mounted to the enclosure.

7. The projection kiosk of claim 1, further comprising a shelf having a foot, the shelf extending laterally from the enclosure and being supported by the enclosure and the foot.

8. The projection kiosk of claim 7, further comprising a user interface supported by the shelf.

9. The projection kiosk of claim 1, wherein the attachment points are positioned at a height of at least about 4 feet above the supporting base to minimize shadowing by personnel positioned between the kiosk and the screen.

10. The projection kiosk of claim 1, wherein the attachment points are positioned at a height of at least about 6 feet.

11. The projection kiosk of claim 1, further comprising a plurality of projectors installed therein.

12. A method of making a projection kiosk, comprising:
forming an enclosure;
installing a frame within the enclosure having attachment points configured to hold in position a plurality of projectors configurable to be aligned with sub-pixel-resolution accuracy to enable projection of pixel-aligned images onto a screen;
mounting a plurality of projectors within the frame; and
installing a heat ducting subsystem within the enclosure, the heat ducting subsystem having an intake to accept air external to the enclosure, baffles to direct air through the plurality of projectors, and an air discharge positioned to direct air away from an area between the plurality of projectors and the screen.

13. The method of claim 12, further comprising installing a shock isolator between the frame and the enclosure.

14. The method of claim 12, further comprising aligning the plurality of projectors to pixel-level accuracy.

15. The method of claim 12, further comprising installing lockable access panels into the enclosure.

16. The method of claim 12, further comprising attaching a shelf to the enclosure and being supported by the enclosure and the foot.

17. The method of claim 12, further comprising installing workstation equipment into the enclosure.

18. A method of projecting images onto a screen using a plurality of projectors, comprising:
providing an enclosure having a supporting base and a plurality of projectors mounted therein;
projecting an image onto the screen having image components projected from the plurality of projectors;
aligning the image components with sub-pixel-resolution accuracy; and
guiding heat generated by the plurality of projectors away from a projection path between the plurality of projectors and the screen.

19. The method of claim 18, further comprising:
installing a workstation within the enclosure; and
coupling the workstation to the plurality of projectors.

20. The method of claim 18, further comprising mounting the plurality of projectors within the enclosure at a height sufficient to minimize shadowing of the projected image by personnel located between the enclosure and the screen.
